(19) United States
(12) Patent Application Publication
(10) Pub. No.: US 2020/0386528 A1
(43) Pub. Date: Dec. 10, 2020

(54) FINS USED TO INCREASE THE STABILITY OF AIRCRAFT AND SPACECRAFT RELATED VEHICLES OR PROPELLED/PROJECTILE OBJECTS

(71) Applicant: Taylor DiAnte' Brown, Jackson, MS (US)

(72) Inventor: Taylor DiAnte' Brown, Jackson, MS (US)

(21) Appl. No.: 16/432,343

(22) Filed: Jun. 5, 2019

(51) Int. Cl. F42B 10/04; B64C 5/06; B64G 1/24

(52) U.S. Cl. CPC F42B 10/04; B64G 1/24; B64C 5/06

(57) ABSTRACT

Fish use their fins to maintain stability when they are swimming. Specifically, their dorsal fin keeps them from rolling over. Some vehicles or objects suffer from stability problems. To solve this problem of stability, fins can be utilized like a fish. By using the methodology that fish use in their fins, vehicles and objects can become more resistant to rolling or yawing.

### BACKGROUND OF THE INVENTION

When vehicles or objects are in motion, there is a need for controlled direction. This controlled direction relates to the stability. Vehicles such as airplanes and submarines depend heavily on stability to maintain their necessary course of travel. There are different parts of these vehicles that support stability. For example, the airplane has horizontal and vertical tails that adjust their flaps accordingly to maintain desired travel. The vertical tail also acts as a vertical stabilizer for the aircraft. The sail on a submarine also acts as a vertical stabilizer to keep the submarine from flipping over. Even though there have been ways to maintain stability on vehicles, there is still room for improvement in some areas. The aircraft deals with stability problems even in the presence of its stabilizers. However, there is a way to increase the stability on vehicles and objects by observing fish.

Fish have fins that help them with stability and to maintain their course of travel. By using this methodology on vehicles and objects, there will be an increase in stability. This invention is to be applied in the field of fluid mechanics. This invention targets making a vehicle or object more stable, resistant to rolling over, and assist in making turns.

### BRIEF SUMMARY OF THE INVENTION

Vehicles and objects need assistance in stability when they are traveling. In order to establish stability, the vehicle or object use stabilizers. The invention uses the methodology of a fish fins on vehicles or objects to maintain its course of travel.

### BRIEF DESCRIPTION OF THE DRAWINGS

FIG. 1A displays the front view of the aircraft. FIG. 1A displays the number 1 pointing to the fin which is positioned in front of the vertical tail of the aircraft.

FIG. 1B displays the top view of the aircraft. FIG. 1B displays the number 2 pointing to the fin which is positioned in front of the vertical tail of the aircraft. The curve line with two slanted lines intersecting its middle on the left wing or left side of the figure denotes the end point of interest of the aircraft.

FIG. 1C displays the side view of the aircraft. FIG. 1C displays the number 3 attached to the fin which is positioned in front of the vertical tail of the aircraft.

### DETAILED DESCRIPTION OF THE INVENTION

The terminology within this section is used for describing the characteristics, functionality, and uses thereof. The term “and/or” used within a sentence denotes any and all combinations of one or more of the associated listed elements. The singular forms of “a,” “an,” and “the” are also intended to include the plural forms unless otherwise stated. It is presumed that scientific, technical, engineering, and mathematical terms are universally defined. It is further understood that these definitions are not limited to their common definitions and may be found through the use of dictionaries or other sources.

There are multiple types of vehicles and objects that can utilize this invention such as: an aircraft, spacecraft, propelled object, and projectile object. The following definitions of an aircraft, spacecraft, propelled object, and projectile object are simply defined, and are not limited to these definitions. An aircraft is any vehicle made to fly within the Earth's atmosphere. A spacecraft is any vehicle made to exit the Earth's atmosphere. A propelled object is any object that has a propulsion system to propel the object in a designated direction. A projectile object is any object that has the capability of being launched from a person's hand or a platform.

This invention entails using the same or similar methodology of the fins on a fish. In applying the invention, if the vehicle or object has a vertical stabilizer towards the middle of the body instead of the back, it can provide more stability. The sail on a submarine for example, which is also referred to as a dorsal fin, is located on the top towards the middle. This sail provides a vertical stabilizer for the submarine to keep it from rolling over. An aircraft also has a vertical stabilizer as well, which is the vertical tail. The vertical tail, however, does not always maintain the stability of the aircraft. To solve this issue, the aircraft, in addition to other vehicles or objects, can use fins similar to the submarine to provide stability.

A fin on a vehicle or object is defined as a structure that comes out of the body of a vehicle or object that provides vertical stability and is not the tail. “Comes out of the body” or “coming out of the body” describes a structure's base who is attached to the body of the vehicle or object. The “tail” relates to the horizontal tail on the sides and the vertical tail on the top and/or bottom. Vertical stability describes a vehicle or object maintaining an upright orientation while resisting rolling and/or yawing.

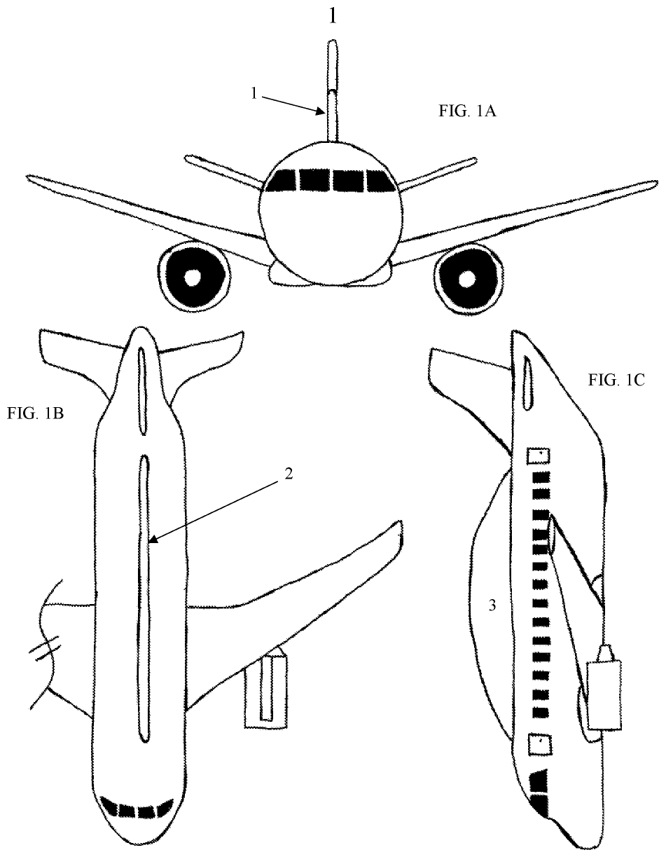

When looking at an example of a vehicle with a tailed configuration and fin, consider FIGS. 1A, 1B, and 1C. FIGS. 1A, 1B, and 1C display examples of a fin being displayed in front of the vertical tail of an aircraft. It is presumed that these figures do not limit the scope or usefulness of the invention. For example, there can be different vehicles or objects with tailed or tailless configurations who have different fin shapes, different number of fins, and at different locations. A tailless configuration describes a vehicle or object that does not have a tail configuration. It is presumed that the processes, manufacturability, and assembly of the fin coming out of the body of vehicle or object should follow the same or similar guidelines of wing and tail configurations for aircrafts.

The claimed invention is:

1. Aircraft and spacecraft related vehicle(s) or propelled/projectile object(s) comprising of fin(s) that provide stability, as defined in the detailed description.
